(19) United States
(12) Patent Application Publication
(10) Pub. No.: US 2004/0137156 A1
(43) Pub. Date: Jul. 15, 2004

(54) Coated solid dosage form and method for preparing same

(76) Inventors: Ernest J. Lee, Kalamazoo, MI (US); John M. Heimlich, Portage, MI (US); Robert M. Noack, Ann Arbor, MI (US); David J.W. Grant, Minneapolis, MN (US)

Correspondence Address: PHARMACIA CORPORATION, GLOBAL PATENT DEPARTMENT, POST OFFICE BOX 1027, ST. LOUIS, MO, 63006, US

(21) Appl. No.: 10/626,374

(22) Filed: Jul. 24, 2003

Related U.S. Application Data
(60) Provisional application No. 60/398,370, filed on Jul. 25, 2002.

(51) Int. Cl. B05D 3/02

(52) U.S. Cl. 427/385.5; 427/212

(57) ABSTRACT

A method of preparing a coated solid dosage form is disclosed wherein a solid dosage form, such as a compressed tablet with active agent dispersed therein, is coated at least twice with a coating solution comprising a water-insoluble coating polymer and a water-soluble pore former, and cured after at least the first coating step. The method of the present invention allows for the production of cured coated solid dosage forms using very short curing times. Coated solid dosage forms produced according to the present invention have been found to have long extended release characteristics.

This application claims the benefit of U.S. Provisional Application Ser. No. 60/398,370, filed Jul. 25, 2002

### FIELD OF THE INVENTION

The present invention relates to coated solid dosage forms and methods for preparing the same, and, more specifically, to film-coated solid dosage forms and a multi-step curing method for preparing the same.

### BACKGROUND OF THE INVENTION

Film-coated solid dosage formulations are well known in the art. Film-coatings are useful in protecting active agents from moisture, air or light, in masking unpleasant taste and odor, in modifying drug release as in enteric-coated and sustained-release compositions, in improving mechanical strength, and in improving product identity and aesthetic appeal, etc.

Film-coating involves the deposition of a thin, substantially uniform film onto the surface of a solid dosage form such as a tablet, powder, granule, nonpareil, capsule and the like. Coatings are generally applied continuously to a moving bed of material, usually by means of a spray technique, although manual application procedures also have been used. The coated dosage forms are then sometimes cured at an elevated temperature to provide a finished product.

The major components in any film-coating formulation generally include a polymer, plastisizer and solvent. Most polymers are employed as solutions in either aqueous or organic solvent-based systems. Alternative systems employ aqueous dispersions of water-insoluble polymers such as, for example, ethylcellulose.

In general, the thicker a film-coating, the greater the degree of protection one would expect a coating to accord the contents of a solid dosage form. Furthermore, the thicker a film-coating the more sustained the release one would expect, of drug from the solid dosage form. Unfortunately, thick film-coatings produced using conventional techniques, such as those described above, have been found to produce coatings with cracks and blisters that create weaknesses in or compromise the layer of protection otherwise accorded by the film-coating. For example, it has been found that solid dosage forms having a 6% by weight coating require excessive curing times, e.g., 2 or 3 days, to fully cure. It has also been found that coated dosage forms with a 6% by weight coating produced in such have defects in the coating, such as cracking or blistering of the coating, rendering the coating useless for its intended purpose. (Unpublished studies).

Film-coated formulations and methods of preparing same have been disclosed in a number of patents, some of which are described below.

U.S. Pat. Nos. 5,472,712, 5,681,585, 5,958,459, 6,129,933 and 6,316,031 disclose stabilized solid controlled release dosage forms, each of which has a coating produced by coating a solid dosage form with an aqueous dispersion of ethylcellulose containing a therapeutically active agent. In each case, a single layer of coating was cured in a single step the coated substrate at an elevated temperature and relative humidity, until the coated dosage form attained a stabilized dissolution profile substantially unaffected by exposure to storage conditions of elevated temperature and/or elevated relative humidity. One reference disclosed that the subject coated solid dosage form was obtained via an oven curing conducted at a temperature of about 60° C. and a relative humidity from 60 to 100% for 48 to 72 hours. The references also disclose that products cured for 2 hours or more at 60° C. dry heat are disadvantageous in that they never reach a stabilized end-point at which the product provides a substantially constant dissolution profile.

It is desirous to have a method for preparing coated solid dosage forms wherein the time required for curing the coating is shortened, and, in turn, shortening the overall production time. Also, it is desirous to have a method for preparing coated solid dosage forms which are free of defect. Cracks or blisters in the coating expose the active agent directly to the environment failing to protect the active agent from moisture, air or light, masking unpleasant taste and odor, modifying drug release as in enteric-coated and sustained-release compositions, improving mechanical strength, and improving product identity and aesthetic appeal, etc.

Therefore, it is an object of the present invention to provide a method for curing solid dosage form coatings in a short period of time. It is another object of the present invention to provide a method of coating solid dosage forms without blistering and/or cracking. Other objects and advantages will become clear upon reading through the disclosure and examples as well as the appended claims.

### SUMMARY OF THE INVENTION

Surprisingly, it has been found that the above objects can be met in one embodiment of the present invention, which provides a method for preparing a coated solid dosage form comprising the steps of (a) applying a first coat of a coating solution to a solid dosage form, the coating solution comprising a water-insoluble polymer and a water-soluble pore former, the solid dosage form having an active agent dispersed therein; (b) curing the solid dosage form coated in step (a); and (c) applying a second coat of the coating solution to the solid dosage form.

In another embodiment, the present invention is directed to a coated solid dosage form produced according to the process of the invention, described above.

### BRIEF DESCRIPTION OF THE DRAWINGS

FIG. 1 is a graph of the release of pramipexole from four different coated tablets of pramipexole coated with either 3% or 5% coating containing either 20% or 25% by weight pore former, measured over time in an aqueous solution buffered at pH 6.8.

FIG. 2 is a graph of the release of clindamycin HCl from five different cured and two uncured coated tablets of clindamycin HCl, coated with either 4% or 6% by weight coating containing either 40% or 50% by weight of a pore former.

### DETAILED DESCRIPTION OF THE INVENTION

The term “water-insoluble polymers” refers to polymers suitable for use in coating pharmaceutically acceptable solid dosage forms. Water-insoluble polymers suitable for use in the methods and coated solid dosage forms of the present invention include cellulose esters such as mono-, di- and triacylates including mixed esters such as, for example, cellulose acetate, cellulose diacetate, cellulose triacetate, cellulose propionate, cellulose acetate butyrate, cellulose acetate propionate, cellulose tripropionate; cellulose ethers such as ethyl cellulose; nylons; polycarbonates; poly(dialkylsiloxanes); poly(methacrylic acid) esters; poly(acrylic acid) esters; poly(phenylene oxides); poly(vinyl alcohols); aromatic nitrogen-containing polymers; polymeric epoxides; regenerated cellulose; membrane-forming materials suitable for use in reverse osmosis or dialysis application; agar acetate; amylose triacetate; beta glucan acetate; acetaldehyde dimethyl acetate; cellulose acetate methyl carbamate; cellulose acetate phthalate; cellulose acetate succinate; cellulose acetate dimethylamino acetate; cellulose acetate ethyl carbonate; cellulose acetate chloroacetate; cellulose acetate ethyl oxalate; cellulose acetate propionate; poly(vinylmethylether) copolymers; cellulose acetate butyl sulfonate; cellulose acetate octate; cellulose acetate laurate; cellulose acetate p-toluene sulfonate; triacetate of locust gum bean; hydroxylated ethylene-vinyl acetate; cellulose acetate butyrate; wax or wax-like substances; fatty alcohols; shellac; zein; hydrogenated vegetable oils; Surelease® (Colorcon, Westpoint, Pa., U.S.A; and the like, and combinations thereof. The water-insoluble polymer is preferably ethylcellulose or Surelease®.

The term “water-soluble pore former” refers to pharmaceutically acceptable material that forms pores, or channels in a coating layer, when incorporated therein. The water-soluble pore former included in the coating solution used to produce the coating of the coated solid dosage forms of the present invention is preferably particulate in nature, with an average particle size from about 0.1 to about 200 μm. In order to be suitable for use in the present invention, the water-soluble pore former must be soluble in water or aqueous media and insoluble in the organic solvent in which the water-insoluble polymer is dissolved during the film-coating process. Suitable pore formers include, alkali metal salts such as, for example, magnesium sulfate, magnesium chloride, magnesium succinate, citric acid, lithium chloride, lithium sulfate, lithium carbonate, sodium carbonate, sodium chloride, sodium bromide, sodium sulfate, sodium acetate, sodium citrate, calcium chloride, calcium bicarbonate, calcium lactate, potassium chloride, potassium sulfate, potassium phosphate, and the like, and mixtures thereof; water soluble hydrophilic polymers such as, for example, cellulose ethers, hydroxypropylcellulose, hydroxypropyl methylcellulose (hereinafter, “HPMC”), hydroxypropylmethylcellulose phthalate, sodium carboxymethylcellulose, protein-derived materials, polyvinylpyrrolidone, cross-linked polyvinylpyrrolidone, polyethylene oxide and water-soluble polydextrose; and saccharides and polysaccharides, such as, for example, pullulan, dextran, sucrose, glucose, fructose, mannitol, lactose, mannose, galactose, sorbitol, Opadry® (Colorcon, Westpoint, Pa., U.S.A.) and the like, and mixtures thereof. The pore former is preferably HPMC or Opadry®.

The coating solution used in coating the solid dosage form according to the method of the present invention comprises a water-insoluble polymer and a water-soluble polymer. In one preferred embodiment, the coating solution comprises Opadry® and ethylcellulose. In anther preferred embodiment, the coating solution comprises Surelease® and Opadry®. The coating solution is applied to the solid dosage form by methods well known to persons having ordinary skill in the art, such as spray coating.

The term “solid dosage form” refers to a substrate such as a tablet, powder, granule, nonpareil, capsule and the like having an active agent dispersed therein.

The term “active agent” refers to any pharmaceutical or physiological agent, composition, bioactive compound, or combination thereof, useful in the diagnosis, cure, mitigation, treatment, or prevention of a disease, or for any other medical purpose. The term “active agent” is intended to be interpreted broadly and is not limited in terms of chemical composition or biological activity. Suitable active agents included in the solid dosage forms coated according to the methods of the present invention, include pramipexole, sumanirole, clindamycin, tolterodine, reboxetine, N-{5-(1,4-diazepan-1-yl)-2-[(3-fluorophenyl)sulfonyl] phenyl} acetaminde and salts thereof, N-(3R)-1-azabicyclo[2.2.2]oct-3-ylfuro[2,3-c]pyridine-5-carboxamide and salts thereof, and other antibiotic compounds or compounds suitable for treatment of disorders having a CNS component. In one preferred embodiment of the present invention, the active agent is pramipexole. In another preferred embodiment, the active agent is clindamycin.

Any of the embodiments of the methods of the present invention can be used to provide a coated solid dosage form, in the form of a coated tablet, powder, granule, nonpareil, capsule and the like, wherein an active agent is dispersed within the solid dosage form.

The coating is applied to the solid dosage form in multiple steps, at least more than one time. It has been found that the application of coating solution to the solid dosage form in at least two application steps, wherein relatively thin layers of coating solution are applied and cured separately provides faster curing than single step curing of the same total amount of coating solution. Each layer of coating solution applied according to the present invention preferably contributes about 0.1% to about 4%, more preferably about 0.5% to about 3%, even more preferably, about 2% to about 3% by weight of the resulting coated solid dosage form. Coated solid dosage forms coated with thick coatings by the application of 5% or more, or even 6% or more of coating solution in multiple steps according to the method of the present invention have coatings that are surprisingly free of cracking or blistering, unlike coated solid dosage forms produced by coating with the same amount of coating followed by curing in a single step. Surprisingly, the amount of time it takes to apply and cure such a thick coating in a single step is significantly longer than the amount of time it takes to apply and cure the same amount of coating in multiple steps. Curing of a thick coating applied in a single step requires at least 24 hours, sometimes 2 or even 3 days to complete. Contrastingly, each curing step in the method of the present invention takes considerably less time because each layer of coating is thinner.

The curing time and conditions for any given coating used in the method and coated solid dosage form of the present invention depend upon the curing properties of the components of the coating solution, particularly, the curing properties of the water-insoluble polymer. Curing is done at or above the glass transition temperature of the water-insoluble water polymer. In general, the higher above the glass transition temperature at which one cures, the shorter the amount of time required to cure the coating. Curing time can be determined experimentally, for any given coating solution and curing conditions. The curing time also depends upon the thickness of the coating layer being cured. Coating and curing conditions are preferably selected such that each curing step conducted for long enough to cure each layer of coating, but, takes less than takes about one minute to about 1 hour, more preferably less than about 30 minutes, even more preferably less than about 15 minutes per curing step. When the water-insoluble polymer is ethylcellulose and the coating is applied to the solid dosage form for about a 3% weight gain, the curing can be performed at a bed temperature of at least about 70° C. for about 15 minutes.

The relative amounts of water-insoluble polymer and water-soluble pore former in the coating solution used in the method of the present invention can significantly affect the release rate of active agent from the solid dosage form coated therewith. Standard assay methods can be used to determine an appropriate proportion of water-insoluble polymer and pore former for any given coating, solid dosage form, and desired release rate. Examples 7 and 12, below, illustrate two such assays. The proportion of pore former in the coating solution is preferably about 10% to about 60%, more preferably about 15% to about 50%, even more preferably, about 20% to about 40%.

The solid dosage form coated according to the present invention is preferably a tablet, referred to hereinafter as a “tablet core”. When the solid dosage form is a tablet core, it optionally contains at least one excipient, such as a buffer, a diluent, a binding agent, a lubricant, a surfactant, or an anti-adherent.

When a buffer is present, it is preferably a buffer designed to maintain the pH at a pH range wherein the active agent dispersed within the tablet core, is stable. Examples of buffers suitable for use in the tablet core include potassium phosphate monobasic, potassium citrate, sodium citrate, sodium phosphate dibasic, diethanolamine, monoethanolamine, sodium bicarbonate, TRIS, and THAM. A buffer is preferably omitted, if the active agent is stable in the tablet core in the absence of a buffer, in order to minimize the size of the tablet core.

Suitable pharmaceutically acceptable diluents for inclusion as excipients in the tablet core illustratively include, either individually or in combination, lactose, including anhydrous lactose and lactose monohydrate; starches, including directly compressible starch and hydrolyzed starches (e.g., Celutab™ and Emdex™); mannitol; sorbitol; xylitol; dextrose (e.g., Cerelose™ 2000) and dextrose monohydrate; dibasic calcium phosphate dihydrate; sucrose-based diluents; confectioner's sugar; monobasic calcium sulfate monohydrate; calcium sulfate dihydrate; granular calcium lactate trihydrate; dextrates; inositol; hydrolyzed cereal solids; amylose; celluloses including microcrystalline cellulose, food grade sources of α- and amorphous cellulose (e.g., Rexcel™) and powdered cellulose; calcium carbonate; glycine; bentonite; polyvinylpyrrolidone; and the like. The diluent or diluents selected preferably exhibit suitable flow properties and, where tablets are desired, compressibility.

A binding agent is preferably included in the tablet core, that imparts sufficient cohesion to the powder being tableted to allow for normal processing operations such as sizing, lubrication, compression and packaging, while still allowing the tablet to disintegrate and the composition to be absorbed upon ingestion. Suitable binding agents include, either individually or in combination, acacia; tragacanth; sucrose; gelatin; glucose; starches such as, but not limited to, pregelatinized starches (e.g., National™ 1511 and National™ 1500); celluloses such as, but not limited to, methylcellulose, microcrystalline cellulose, and carmellose sodium (e.g., Tylose™); alginic acid and salts of alginic acid; magnesium aluminum silicate; PEG; guar gum; polysaccharide acids; bentonites; povidone, for example povidone K-15, K-30 and K-29/32; polymethacrylates; HPMC, hydroxypropylcellulose (e.g., Klucel™); and ethylcellulose (e.g., Ethocel™).

When the active agent is pramipexole, pregelatinized starch and HPMC, or a mixture of the two are particularly preferred binders.

When the active agent is clindamycin, microcrystalline cellulose is a particularly preferred binder, because of its known chemical compatibility with that particular drug. The use of extragranular microcrystalline cellulose (that is, microcrystalline cellulose added to a wet granulated composition after a drying step) can also be used to improve hardness (for tablets) and/or disintegration time. Microcrystalline cellulose included in dry granulation similarly improves hardness of a tablet core.

Suitable pharmaceutically acceptable lubricants (including anti-adherents and/or glidants) for inclusion as excipients in the tablet core include, either individually or in combination, glyceryl behenate (e.g., Compritol™ 888); stearic acid and salts thereof, including magnesium, calcium and sodium stearates; hydrogenated vegetable oils (e.g., Sterotex™); colloidal silica; colloidal silicon dioxide, talc; waxes; boric acid; sodium benzoate; sodium acetate; sodium fumarate; sodium chloride; DL-leucine; PEG (e.g., Carbowax™ 4000 and Carbowax™ 6000); sodium oleate; sodium lauryl sulfate; and magnesium lauryl sulfate. Colloidal silicon dioxide and magnesium stearate are particularly preferred for use as lubricants in the tablet cores of the present invention. Particularly suitable lubricants for inclusion as excipients in the tablet core of the present invention reduce friction between the equipment and granulated mixture during compression of the tablet cores.

Preferred anti-adherents or glidants include colloidal silicon dioxide, talc, cornstarch, DL-leucine, sodium lauryl sulfate and metallic stearates, more preferably colloidal silicon dioxide or Talc, even more preferably, colloidal silicon dioxide. Such anti-adherents or glidants are used, for example, to reduce formulation sticking to equipment surfaces and also to reduce static in the blend.

Other excipients such as colorants, flavors and sweeteners are known in the pharmaceutical art and can be used in the solid dosage form or coating applied to the solid dosage form in the method of the invention.

The present invention is further illustrated by the following examples. These examples are intended to be illustrative of the invention and should not be used to limit or restrict its scope.

### EXAMPLES

### Example 1

Compressed tablets of pramipexole were prepared according to the following procedure, using tablet core ingredient amounts set forth in Examples 2-5, below.

1. All tablet core ingredients (i.e., pramipexole, HPMC 2208 4000 cps, pregelatinized starch, colloidal silicon dioxide, and magnesium stearate) were passed through a pharmaceutical screen of about a 30 mesh.

2. All the tablet core ingredients except magnesium stearate were dry mixed at about 24 rpm for about 10 to about 30 minutes in a low shear mixer (a V blender or bin blender).

3. The magnesium stearate was weighed and combined in the blender with the remainder of the mixture from step 3, and mixed for an additional 2 to 5 minutes.

4. Samples of the resulting mixture from step 4 were compressed into tablets, using a tablet press.

5. The compressed tablets were then coated and cured, as described in Examples 2-5, below.

### Example 2

Compressed pramipexole tablets were prepared as described in Example 1, above, using the amounts of tablet core ingredients shown in Table 1, below; and coated with a coating solution comprising Surelease® and about 25% by weight pore former (Opadry®), as described herein below.

TABLE 1

| | Amount | % by |
|---|---|---|
| Component | (mg) | Weight |
| Pramipexole | 0.375 | 0.1 |
| HPMC 2208 4000 cps | 140 | 38.8 |
| Pregelatinized Starch | 206.48 | 57.3 |
| Colloidal | 1.4 | 0.4 |
| Silicon Dioxide | | |
| Magnesium Stearate | 1.75 | 0.5 |
| Surelease ® | 7.88 | 2.2 |
| Opadry ® | 2.63 | 0.7 |
| Total | 360.5 | 100 |

The coating solution used in this Example was prepared, first, by adding 6.0037 g Opadry® to 106.682 g water, and mixing for 45 minutes. 72.045 g Surelease® was then added to the Opadry® mixture and mixed for an additional 30 minutes to provide the coating solution.

The coating solution was applied to the compressed tablets, for a theoretical weight gain of about 3%. Table 1 shows the amount of Surelease® and Opadry® applied to each tablet for a theoretical weight gain of about 3% per tablet, in this step of the present procedure.

The coated tablets were then cured using either a Vector LCDS coating pan or a Thomas Accela-Cotta coating pan for about 15 minutes at a bed temperature of at least about 70° C. After curing, the temperature was ramped down over a period of about 8 minutes to an exhaust temperature of about 45° C.

### Example 3

Compressed pramipexole tablets were prepared as described in Example 1, above, using the amounts of tablet core ingredients shown in Table 1, below; and coated with a coating solution comprising Surelease® and about 20% by weight pore former (Opadry®), as described herein below.

TABLE 2

| | Amount | % by |
|---|---|---|
| Components | (mg) | Weight |
| Pramipexole | 0.375 | 0.1 |
| HPMC 2208 4000 cps | 140 | 38.8 |
| Pregelatinized Starch | 206.48 | 57.3 |
| Colloidal | 1.4 | 0.4 |
| Silicon Dioxide | | |
| Magnesium Stearate | 1.75 | 0.5 |
| Surelease ® | 8.4 | 2.3 |
| Opadry ® | 2.1 | 0.6 |
| Total | 360.5 | 100 |

The coating solution used in this Example was prepared, first, by adding 4.8012 g Opadry® to 103.04114 g water, and mixing for 45 minutes. 76.8192 g Surelease® was then added to the Opadry® mixture and mixed for an additional 30 minutes to provide the coating solution.

The coating solution was applied to the compressed tablets, for a theoretical weight gain of about 3%. Table 2, above, shows the amount of Surelease® and Opadry® applied to each tablet for a theoretical weight gain of about 3% per tablet, in this step of the present procedure.

The coated tablets were then cured using either a Vector LCDS coating pan or a Thomas Accela-Cotta coating pan for about 15 minutes at a bed temperature of at least about 70° C. After curing, the temperature was ramped down over a period of about 8 minutes to an exhaust temperature of about 45° C.

### Example 4

Compressed pramipexole tablets were prepared as described in Example 1, above, using the same amounts of each tablet core ingredient per tablet as were used in the tablets produced as described in Example 2, above. As in Example 2, the tablets were also coated with a coating solution comprising Surelease® and about 25% by weight pore former (Opadry®). However, in the present Example, the tablets were coated and cured twice. The amount of each component used in each tablet prepared as described below, is shown in Table 3:

TABLE 3

| | Amount |
|---|---|
| Components | (mg) |
| Pramipexole | 0.375 |
| HPMC 2208 4000 cps | 140 |
| Pregelatinized Starch | 206.48 |
| Colloidal | 1.4 |
| Silicon Dioxide | |
| Magnesium Stearate | 1.75 |
| Surelease ® | 13.13 |
| Opadry ® | 4.38 |
| Total | 367.5 |

The coating solution used in this Example was prepared, first, by adding about 10.0025 g Opadry® to about 177.7367 g water and mixing for about 45 minutes. About 120.03 g Surelease® was then added to the Opadry® mixture and mixed for an additional 30 minutes to provide a coating solution. The coating solution was applied to the compressed tablets for a theoretical weight gain of about 3%.

The coated tablets were then cured using a Vector LCDS coating pan (12″) or a Thomas Accela-Coata coating pan (24″) for about 15 minutes at a bed temperature of at least above 70° C. After curing, temperature was ramped down over a period of about 8 minutes to an exhaust temperature of about 45° C.

The coating step was then repeated for a total tablet weight gain of about 5%, followed by curing for about 15 minutes at a bed temperature of at least about 70° C. After curing, temperature was ramped down over a period of about 8 minutes to an exhaust temperature of about 45° C.

### Example 5

Compressed pramipexole tablets were prepared as described in Example 1, above, using the same amounts of each tablet core ingredient per tablet as were used in the tablets produced as described in Example 3, above. As in Example 3, the tablets were also coated with a coating solution comprising Surelease® and about 20% by weight pore former (Opadry®)., However, in the present Example, the tablets were coated and cured in two steps. The amount of each component used in each tablet prepared as described in the present Example is shown in

TABLE 4

| | Amount |
|---|---|
| Components | (mg) |
| Pramipexole | 0.375 |
| HPMC 2208 4000 cps | 140 |
| Pregelatinized Starch | 206.48 |
| Colloidal Silicon Dioxide | 1.4 |
| Magnesium Stearate | 1.75 |
| Sure1ease ® | 14.0 |
| Opadry ® | 3.5 |
| Total | 367.5 |

The coating solution used in this Example was prepared, first, by adding 8.002 g Opadry® to 171.7352 g water and mixing for 45 minutes. 128.032 g Surelease® was then added to the resulting mixture and mixed for an additional 30 minutes to provide a coating solution.

The coating solution was applied to tablets for a theoretical weight gain of 3% per tablet, followed by curing, cooling, and a second coating step, for a total theoretical weight gain of about 5% per tablet, using the same coating, curing, and cooling procedure described in Example 4, above.

### Example 6

Coated compressed tablets of pramipexole are produced as described in Example 1, using the same proportions of tablet core ingredients as are described in any one of Examples 2-5, above, and coated with the same coating mixture set forth in said Example.

In the present Example, the tablets are coated in a single coating step for a theoretical weight gain of about 5%. The tablets are then cured and cooled as described in Examples 2 or 3, above.

The resulting tablets are found to contain imperfections in the tablet coating, such as blisters or cracks or a combination of the two. Such imperfections were not found to be present in any of the tablets produced according to Examples 2-5, above.

### Example 7

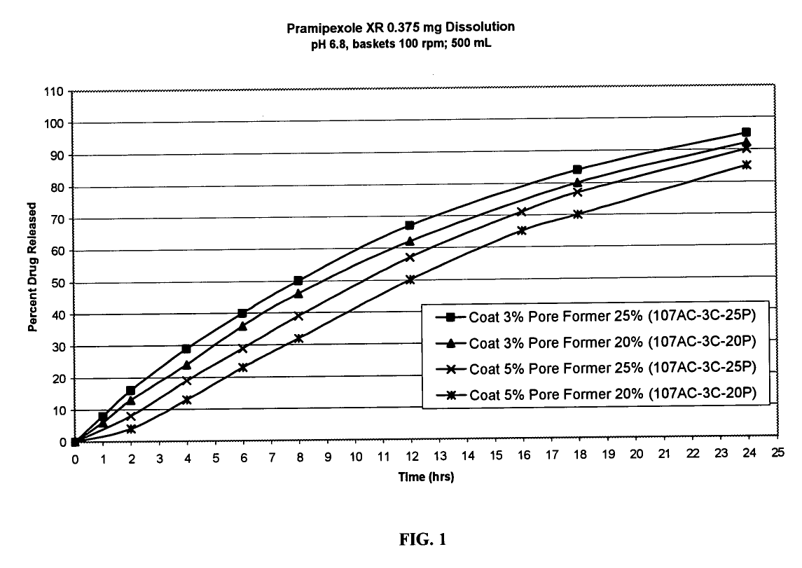

The four different types of coated tablets of pramipexole produced as described in Examples 2-5 (3% coating with 25% pore former, 3% coating with 20% pore former, 5% coating with 25% pore former, and 5% coating with 20% pore former), were tested for release rate over time, in an aqueous solution of pH 6.8. A plot of the release rate results is set forth in FIG. 1, below.

FIG. 1 shows that each of the four types of coated tablets tested showed an extended rate of release of pramipexole, even after 24 hours. However, the two types of tablets with 5% coating had a significantly slower rate of release compared to those with only a 3% coating. The tablets with only 20% pore former and about a 5% coating produced the slowest release rate of all the tablet types tested.

### Example 8

Various batches of compressed tablets of clindamycin HCl were prepared, using a roller-compaction procedure. A 20 mesh screen was used to screen all tablet core ingredients used to make the compressed tablets (i.e., clindamycin HCl, Ethocel, and magnesium stearate). The amounts of each component used in the production of each such tablet, and the procedure used to coat and cure each such tablet is set forth in Examples 9-11, below.

### Example 9

Compressed clindamycin HCl tablets were produced as described in Example 8, above, using the amounts of tablet core ingredients shown in Table 5, below:

TABLE 5

| | Amount |
|---|---|
| Components | (mg) |
| Clindamycin HCl | 651.5 |
| Ethocel Std. 10 Premium FP | 207.59 |
| Ethylcellulose | |
| Magnesium Stearate NF Powder | 4.44 |
| Food Grade-V-Bolted | |
| HPMC 2910 USP 3 CPS | 6.9 |
| Surelease ® Clear Grade E-7-19010 | 27.6 |
| Total | 898.03 |

The compressed clindamycin HCl tablets were coated with a coating solution comprising Surelease® and about 20% HPMC, a pore former, in the amounts shown in Table 5, for a total theoretical weight gain of about 4%. The coating was applied in two steps, with curing and cooling steps used after each coating step, in a similar way as is described in Examples 2-5 following each coating step. Coating solution was applied for about a 2% weight gain in each of the two coating steps.

### Example 10

Compressed clindamycin HCl tablets were produced as described in Example 8, above, using the amounts of tablet core ingredients shown in Table 6, below:

TABLE 6

| | Amount |
|---|---|
| Components | (mg) |
| PNU-21251F Clindamycin HCl | 651.5 |
| Ethocel Std. 10 Premium FP | 207.59 |
| Ethylcellulose | |
| Magnesium Stearate NF Powder | 4.44 |
| Food Grade-V-Bolted | |
| Hydroxypropyl Methylcellulose 2910 | 10.4 |
| USP 3 CPS | |
| Surelease ® Clear Grade E-7-19010 | 41.4 |
| Total | 915.33 |

The compressed clindamycin HCl tablets were coated with a coating solution comprising Surelease® and about 20% HPMC, in the amounts per tablet shown in Table 6, for a total theoretical weight gain of about 6%. The coating was applied in three steps of 2% coating each, with curing and cooling steps similar to those described in Examples 2-5 following each coating step.

### Example 11

Compressed clindamycin HCl tablets were produced as described in Example 8, above, using the amounts of tablet core ingredients shown in Table 7, below:

TABLE 7

| | Amount |
|---|---|
| Components | (mg) |
| PNU-21251F Clindamycin HCl | 651.5 |
| Ethocel Std. 10 Premium FP | 207.59 |
| Ethylcellulose | |
| Magnesium Stearate NF Powder | 4.44 |
| Food Grade-V-Bolted | |
| Hydroxypropyl Methylcellulose 2910 | 12.1 |
| USP 3 CPS | |
| Surelease ® Clear Grade E-7-19010 | 48.4 |
| Total | 924.03 |

The compressed clindamycin HCl tablets were coated with a coating solution comprising Surelease® and about 20% HPMC, in the amounts per tablet shown in Table 6, for a total theoretical weight gain of about 6%. The coating was applied in three steps of 2% coating each, with curing and cooling steps similar to those described in Examples 2-5 following each coating step.

### Example 12

Coated compressed clindamycin HCl tablets produced as described in Examples 10 and 11 were found to have a release rate that was so slow as to have limited utility as a drug release agent. Several additional samples of coated compressed clindamycin HCl tablets were produced using coating mixtures comprising Surelease® and either 40% or 50% pore former (HPMC), for a total weight percent of coating of either 4% or 6%. The same amounts of tablet core ingredients were used as were used in Examples 9-10, above. Except for one set of tablets produced with 6% coating and 40% pore former, all of the tablets were coated and cured thre times, in the same way as described in Examples 9-10.

Coated tablets were also produced with a coating for a theoretical weight gain of 6%, and coated only a single time. However, the coatings of this last set of tablets were found to have imperfections, such as blisters or cracks, or both. These tablets were not included in the release rate study, described below.

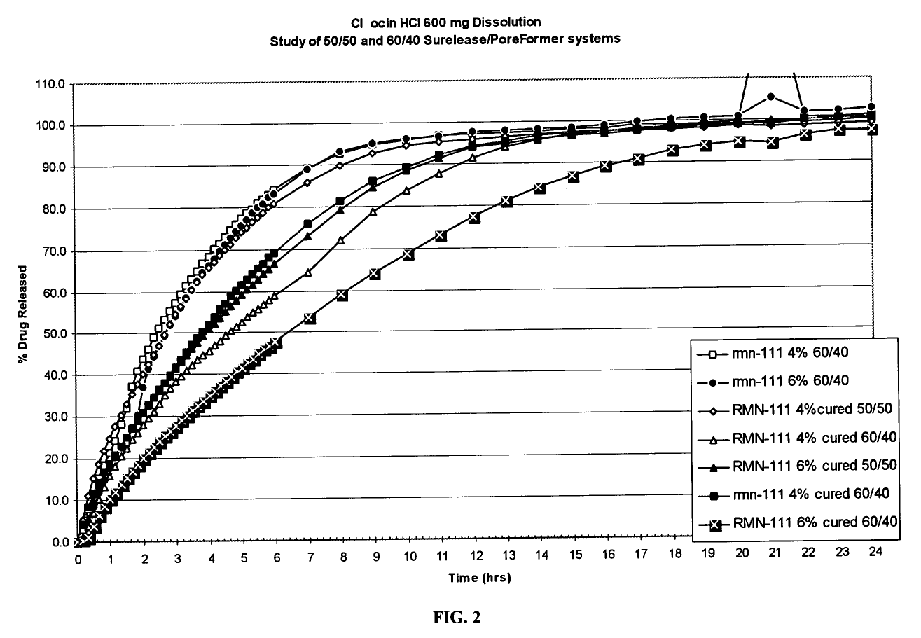

A clindamycin HCl release rate study was then conducted on all but the single step cured tablets produced as described above. The tablets were each placed in an aqueous phosphate buffer solution, with a pH of 6.8, and the amount of clindamycin HCl released into the solution was measured at various time points. A plot of the study results is shown in FIG. 2, below. FIG. 2 shows that tablets with about 6% coating and about 40% pore former had a steady, slow, release rate, releasing about 80% of the clindamycin by about 13 hours into the study, while the 4% coated 40% pore former cured formulation had 80% release between 8 and 9 hours, the 6% coated 50% pore-former had 80% release at 8 hours, and all of the other tablets achieved 80% release at about 5.5 hours. Surprisingly, the tablets with 6% and 4% uncured coating (with about 40% pore former) had the same release rate as one another, the fastest and least extended release rate of any of the coated tablets tested.

What is claimed is:

1. A method for preparing a coated solid dosage form comprising the steps of:
(a) applying a first coat of a coating solution to a solid dosage form, the coating solution comprising a water-insoluble polymer and a water-soluble pore former, the solid dosage form having an active agent dispersed therein;
(b) curing the solid dosage form coated in step (a); and
(c) applying a second coat of the coating solution to the solid dosage form.

2. The method of claim 1, wherein applying the first coat of the coating solution to the solid dosage form in step (a) results in a percent weight gain of about 0.5% to about 3%.

3. The method of claim 1, wherein the curing step is performed at a temperature above a glass transition temperature for the water-insoluble polymer, for a sufficient amount of time to cure the coated solid dosage form.

4. The method of claim 3, wherein the curing step is completed in less than about 30 minutes.

5. The method of claim 3, wherein the curing step is performed at a bed temperature of at least about 70° C. for at least about 15 minutes.

6. The method of claim 1 wherein the water-insoluble polymer is selected from the group consisting essentially of cellulose esters, mono-, di- and triacylates, cellulose acetate, cellulose diacetate, cellulose triacetate, cellulose propionate, cellulose acetate butyrate, cellulose acetate propionate, cellulose tripropionate, ethylcellulose, nylons, polycarbonates, poly(dialkylsiloxanes), poly(methacrylic acid) esters, poly(acrylic acid) esters, poly(phenylene oxides), poly(vinyl alcohols), aromatic nitrogen-containing polymers, polymeric epoxides, regenerated cellulose, membrane-forming materials suitable for use in reverse osmosis or dialysis application, agar acetate, amylose triacetate, beta glucan acetate, acetaldehyde dimethyl acetate, cellulose acetate methyl carbamate, cellulose acetate phthalate, cellulose acetate succinate, cellulose acetate dimethylamino acetate, cellulose acetate ethyl carbonate, cellulose acetate chloroacetate, cellulose acetate ethyl oxalate, cellulose acetate propionate, poly(vinylmethylether) copolymers, cellulose acetate butyl sulfonate, cellulose acetate octate, cellulose acetate laurate, cellulose acetate p-toluene sulfonate, triacetate of locust gum bean, hydroxylated ethylene-vinyl acetate, cellulose acetate butyrate, wax or wax-like substances, fatty alcohols, shellac, zein, hydrogenated vegetable oils, Surelease® and any combination thereof.

7. The method of claim 1 wherein the water-insoluble polymer is ethylcellulose.

8. The method of claim 1 wherein the water-soluble pore former is selected from the group consisting essentially of magnesium sulfate, magnesium chloride, magnesium succinate, citric acid, lithium chloride, lithium sulfate, lithium carbonate, sodium carbonate, sodium chloride, sodium bromide, sodium sulfate, sodium acetate, sodium citrate, calcium chloride, calcium bicarbonate, calcium lactate, potassium chloride, potassium sulfate, potassium phosphate, cellulose ethers, polyvinylpyrrolidone, cross-linked polyvinylpyrrolidone, polyethylene oxide, water-soluble polydextrose, pullulan, dextran, sucrose, glucose, fructose, mannitol, lactose, mannose, galactose, sorbitol, Opadry® and any combination thereof.

9. The method of claim 1 wherein the water-soluble pore former is hydroxypropyl methylcellulose.

10. The method of claim 1 wherein the solid dosage form is selected from the group consisting of a tablet, powder, granule, nonpareil and capsule.

11. The method of claim 1, wherein the solid dosage form is a tablet.

12. The method of claim 1 wherein the active agent is selected from the group consisting of pramipexole and clindamycin.

13. The method of claim 1, further comprising a step of curing the solid dosage form after applying the second coat in step (c).

14. The method of claim 1, wherein the water-soluble pore former is present in the coating in an amount that promotes extended release of the active agent from the coated solid dosage form.

15. The method of claim 14, wherein the water soluble pore former is about 10% by weight to about 60% by weight of the coating solution.

16. A coated solid dosage form produced according to the method of claim 1.
